(19) United States
(12) Patent Application Publication
(10) Pub. No.: US 2026/0064481 A1
(43) Pub. Date: Mar. 5, 2026

(54) CONFIGURABLE DEPTH LIMIT FOR CACHE PREFETCHING

(71) Applicant: International Business Machines Corporation, Armonk, NY (US)

(72) Inventors: Jacob ENGELBRECHT, Danbury, CT (US); Rafaela FROTA, Poughkeepsie, NY (US); Andres JARAMILLO, Tampa, FL (US); Cameron Alexander MILLER, Kingston, NY (US); Hubertus FRANKE, Cortlandt Manor, NY (US); John S. WERNER, Fishkill, NY (US)

(21) Appl. No.: 18/818,568

(22) Filed: Aug. 28, 2024

(51) Int. Cl. G06F 9/50; G06F 9/30

(52) U.S. Cl. CPC G06F 9/505; G06F 9/30047; G06F 9/5094

(57) ABSTRACT

In some implementations, a CPU may determine a measure of importance associated with executing a workload. The CPU may determine a cache prefetching depth limit associated with the measure of importance. The CPU may perform, as part of executing of the workload, cache prefetching up to a depth identified by the cache prefetching depth limit.

### BACKGROUND

The present invention relates to utilizing a cache for workloads executing on computing devices, and for example, relates to cache prefetching for workloads. A cache may include a memory that stores data to enable expedited access to the data by a central processing unit. A workload may include an amount of time and an amount of computational resources a system or network takes to complete a task or generate a particular output. As an example, the workload may be an application. The workload may be executed on different computing devices.

### SUMMARY

In some implementations, a method includes determining a measure of importance associated with executing a workload; determining a cache prefetching depth limit associated with the measure of importance; and performing, as part of executing of the workload, cache prefetching up to a depth identified by the cache prefetching depth limit.

In some implementations, a system comprising: a processing unit to: determine that one or more instructions are to be stored in a cache for execution of a workload; obtain sustainability information regarding cache prefetching associated with the execution of the workload; determine, based on the sustainability information, whether the cache prefetching is to be limited to a cache prefetching depth; perform the cache prefetching up to the cache prefetching depth limit when the cache prefetching is to be limited to the cache prefetching depth limit; and perform the cache prefetching independent of the cache prefetching depth limit when the cache prefetching is not to be limited to the cache prefetching depth limit.

In some implementations, a computer program product comprising: one or more computer readable storage media, and program instructions collectively stored on the one or more computer readable storage media, the program instructions comprising: program instructions to determine that one or more instructions are to be stored in a cache for execution of a workload; program instructions to obtain sustainability information regarding cache prefetching associated with the execution of the workload; and program instructions to perform, as part of the execution of the workload, cache prefetching to a cache prefetching depth when the sustainability information identifies the cache prefetching depth.

### BRIEF DESCRIPTION OF THE DRAWINGS

FIG. 1 is a diagram of an example system described herein.

FIG. 2 is a flowchart of an example process associated with limiting cache prefetching based on sustainability information.

FIG. 3 is a diagram of an example computing environment in which systems and/or methods described herein may be implemented.

FIG. 4 is a diagram of example components of one or more devices of FIG. 1.

FIG. 5 is a flowchart of an example process to assign workloads associated with limiting cache prefetching based on sustainability information.

### DETAILED DESCRIPTION

The following detailed description of example implementations refers to the accompanying drawings. The same reference numbers in different drawings may identify the same or similar elements.

Computing devices may execute workloads. A workload may include an amount of time and an amount of computational resources a system or network takes to complete a task or generate a particular output. As an example, the workload may be an application, a function, a task, among other examples of operations performed by a central processing unit (CPU). The workload may be executed on different computing devices.

As part of executing the workload, the CPU accesses data. In an effort to expedite access to the data, the data may be stored in a cache. In some situations, the CPU may take advantage of cache prefetching to conceal memory latencies and, thus, to improve performance of the CPU with respect to executing the workload. Cache prefetching may include fetching instructions or data from a current storage location (e.g., a main memory) and loading the instructions and the data in the cache in anticipation of the instructions and the data being used as part executing the workload.

As an example, during or prior to execution of a current instruction for the workload, a next instruction and/or data (anticipated to be used for the workload) may be fetched, a subsequent instruction and/or data (anticipated to be used for the workload) may be fetched, and so on. In this regard, cache prefetching may be instructions and/or data at different depth (or different level) to be fetched in anticipation of the instructions and/or data being used during execution of the workload. In this this regard, cache prefetching may further improve performance of the CPU with respect to executing the workload.

Existing cache prefetching is often too ambitious because existing cache prefetching may fetch more instructions and/or data than will be used and/or will be needed as part of executing the workload. For example, existing cache prefetching may fetch instructions and/or data at more depths than will be used and/or will be needed as part of executing the workload.

Additionally, the cache may consume a significant amount of resources of the CPU. Accordingly, fetching instructions and/or data (at multiple depths), that are not used, unnecessarily consumes resources of the CPU and unnecessarily consumes energy. In other words, fetching instructions and/or data that are not used is a waste of energy. In some situations, the workload may be executed without regard to aggressive performance. In this regard, cache prefetching may be unnecessary for the workload.

In some situations, instead of being stored in a level 1 cache, the unused instructions and/or data (that have been prefetched) may be stored in lower levels of cache (e.g., a level 2 cache, a level 3 cache, and so on). A level 1 cache may refer to a cache that is closest to a core of the CPU, a level 2 cache may refer to a cache that is next closest to the core, and so on. In some situations, cache prefetching may result in cache misses, if the prefetched instructions and/or data are placed directly into the cache.

As explained herein, cache prefetching may consume an unnecessary amount of resources and energy, especially when the instructions and/or data are not used by the workload. Accordingly, there is a need in the art for more energy efficient, more resource efficient, and more sustainable cache prefetching.

Implementations described herein are directed to addressing the technical problems discussed above regarding cache prefetching consume an unnecessary amount of resources and energy. For example, implementations described herein are directed to setting a cache prefetching depth limit for cache prefetching and performing the cache prefetching up to a depth identified by the cache prefetching depth limit. “Cache prefetching” may be referred to as “prefetching” and “cache prefetching depth limit” may be referred to as “prefetching depth limit.” A prefetching depth may be used to refer to a depth (or level) associated with an instruction and/or data. For example, a prefetching first depth may be used to refer to a next instruction and/or data, a prefetching second depth may be used to refer to a subsequent instruction and/or data, and so on.

In some situations, the prefetching depth limit may be on a system level. For example, the prefetching depth limit may apply to multiple workloads executed by a CPU of a host device. In some implementations, a different depth limit may apply to multiple workloads executed by another CPU included in the host device.

In some situations, the prefetching depth limit may be on per process level. For example, different prefetching depth limits may apply to different workloads. In this regard, implementations described herein are directed to determining a measure of importance of the different workloads and determining different prefetching depth limits for different measures of importance. For example, a first workload may be associated with a first measure of importance that exceeds a second measure of importance associated with a second workload. In this regard, the second workload may be associated with a prefetching depth limit that exceeds a prefetching depth limit associated with the first workload. For example, in some implementations, the prefetching depth limit may increase as the measure of importance (of a workload) decreases.

In some implementations, the measure of importance of a workload may indicate a measure of importance with respect to performance of the workload (e.g., indicate a measure of performance to be achieved with respect to executing the workload). In this regard, a first workload that is to meet a higher level of performance (e.g., a database application) may not be associated with a prefetching depth limit. Conversely, a second workload that is to meet a lower level of performance (e.g., a background operation, a cleanup operation, a backup operation) may be associated with a prefetching depth limit. For the second workload associated with the lower level of performance, sustainability may be prioritized over performance. Sustainability may refer to preserving resources and energy. In this regard, in an effort to preserve resources (e.g., CPU resources) and energy, the cache prefetching depth limit may be identified for the second workload.

In some implementations, a measure of importance of a workload may be determined by a system administrator associated with the host device. In some implementations, an efficiency of cache prefetching for different workloads may be measured. In this regard, a prefetching depth limit may be determined to limit prefetching for workloads facing a number threshold of cache misses (e.g., a higher number of cache misses) and/or facing a number threshold of unused cache prefetches. The number threshold may be determined by the system administrator. In some situations, an efficiency (or a usage) of prefetched instructions and/or data may not be properly predicted for some workloads. Accordingly, a prefetching depth limit may be determined for such workloads to preserve energy, preserve resources of the CPU, and preserve local cache space that would have been used to fetch ultimately unused cache lines.

In some implementations, the cache prefetching depth limit and/or the measure of importance may be identified by sustainability information. The sustainability information may be included in a program context block of a workload. The program context block may include information regarding the workload. The program context block may define the workload, may define a state of the workload (e.g., different stages of execution of the workload), and may include information that may be used by instructions that are executed as part of execution of the workload. The program context block may be used by the CPU for the purpose of switching between execution of the workload and execution of another workload. In some implementations, the program context block may include a data structure and the sustainability information may include bits of the program context block. The data structure may be used by operating systems to keep track of process state and information of processes executed by the operating systems. The bits may indicate a measure of importance of the workload and/or a cache prefetching depth limit for the workload. The sustainability information may be defined by the system administrator.

In some implementations, the CPU may determine the measure of importance and/or the cache prefetching depth limit based on the sustainability information. In some situations, the CPU may obtain the sustainability information as a result of context switching between the workload and another workload. As part of the context switching, the CPU may obtain the program context block of a workload and obtain the sustainability information from the program context block.

Accordingly, by determining a measure of importance of a workload and by determining a cache prefetching depth limit for the workload, implementations described herein preserve energy, preserve resources of the CPU, and preserve local cache space that would have been used to fetch cache lines that are ultimately unused.

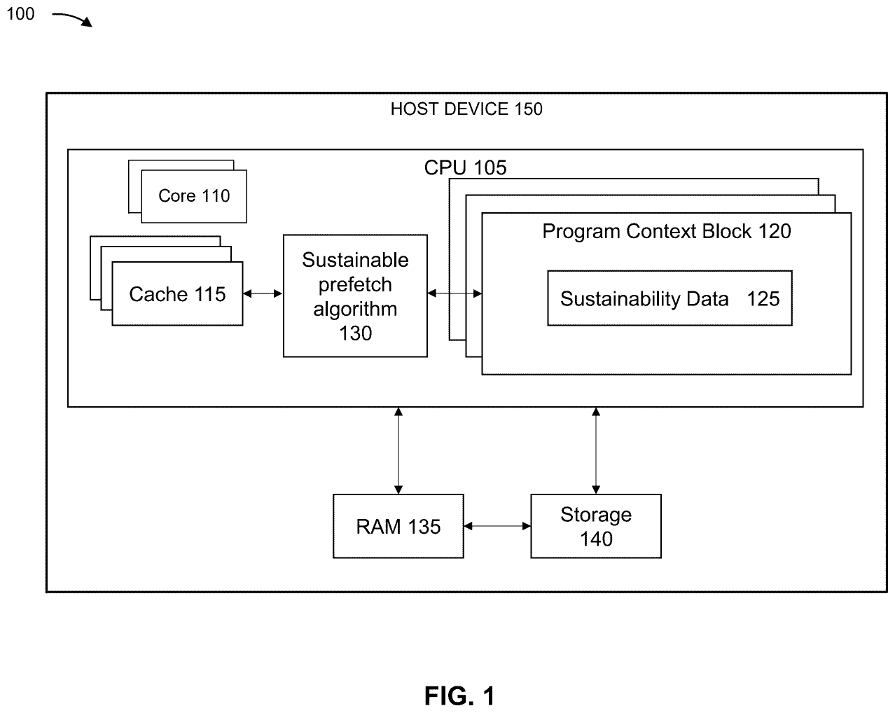

FIG. 1 is a diagram of an example implementation 100 described herein. As shown in FIG. 1, implementation 100 may include a CPU 105. As show in FIG. 1, CPU 105 may include one or more cores 110 (individually “core 110” or collectively “cores 110”), one or more cache 115 (individually “cache 115” or collectively “caches 115”), one or more program context blocks 120 (individually “program context block 120” or collectively “program context blocks 120”), and a sustainable prefetch algorithm 130. A core 110 may include a processor core of a CPU.

A cache 115 may include memory that is located in a processor chip package(s) and is typically used for data or code that should be available for rapid access by threads or cores of CPU 105. In some implementations, CPU 105 may include multiple caches 115. In this regard, caches 115 may be organized into multiple levels depending upon relative proximity to a processing circuitry of CPU 105. For example, a level 1 cache may refer to a cache that is closest to a core 110 of CPU 105, a level 2 cache may refer to a cache that is next closest to the core 110, and so on.

As shown in FIG. 1, a program context block 120 may include information regarding a workload. In this regard, a first program context block 120 may include information regarding a first workload, a second program context block 120 may include information regarding a second workload, and so on. CPU 105 may perform context switching by switching between different program context blocks 120 as part of switching between executing different workloads.

As shown in FIG. 1, a program context block 120 of a workload may include sustainability information of a workload. For example, the sustainability information of the workload may indicate a measure of importance of the workload. The measure of importance may indicate a measure of performance to be achieved as part of execution of the workload.

Additionally, or alternatively, the sustainability information may indicate a cache prefetching depth limit for cache prefetching performed as part of the execution of the workload. For example, if the workload is associated with a lower measure of performance, the sustainability information may identify a cache prefetching limit. Conversely, if the workload is associated with a higher measure of performance, the sustainability information may not identify a cache prefetching limit. In some implementations, the cache prefetching limit may decrease as a measure of importance (e.g., a measure of performance) increases. For example, a first workload associated with a first measure of importance may have a cache prefetching limit of a first level, a second workload associated with a second measure of importance (exceeding the first measure of importance) may have a cache prefetching limit of a second level (e.g., one or more levels of cache prefetching), and so on. In some implementations, the sustainability information may be included in one or more bits of the program context block 120 that are not used (e.g., that are not typically used).

In some examples, sustainable prefetch algorithm 130 may be implemented on a component of CPU 105, such as a circuit. Sustainable prefetch algorithm 130 may determine a cache prefetching depth limit of a workload based on sustainability information of the workload and may limit cache prefetching (for the workload) to a depth identified by the cache prefetching depth limit.

As shown in FIG. 1, example implementation 100 may include a random access memory (RAM) 135 and a storage 140. In some examples, RAM 135 may include instructions and/or data for different workloads. While example implementation 100 includes a RAM, in some implementations, example implementation 100 may include another type of storage device, such as read-only memory (ROM), erasable programmable read-only memory (EPROM or Flash memory), among other examples.

Storage 140 may include a storage device that stores data that may be used by CPU 105 to perform various operations. In some examples, storage 140 may include a volatile memory device or a non-volatile memory device. In some examples, storage 140 may include user data and/or operating system data.

In some implementations, CPU 105, RAM 135, and storage 140 may be part of a system. For example, as show in FIG. 1, CPU 105, RAM 135, and storage 140 may be included in a host device 150. Host device 150 may include a communication device and a computing device. For example, host device 150 may include a server, a wireless communication device, a mobile phone, a user equipment, a laptop computer, a tablet computer, a desktop computer, and/or a similar type of device.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

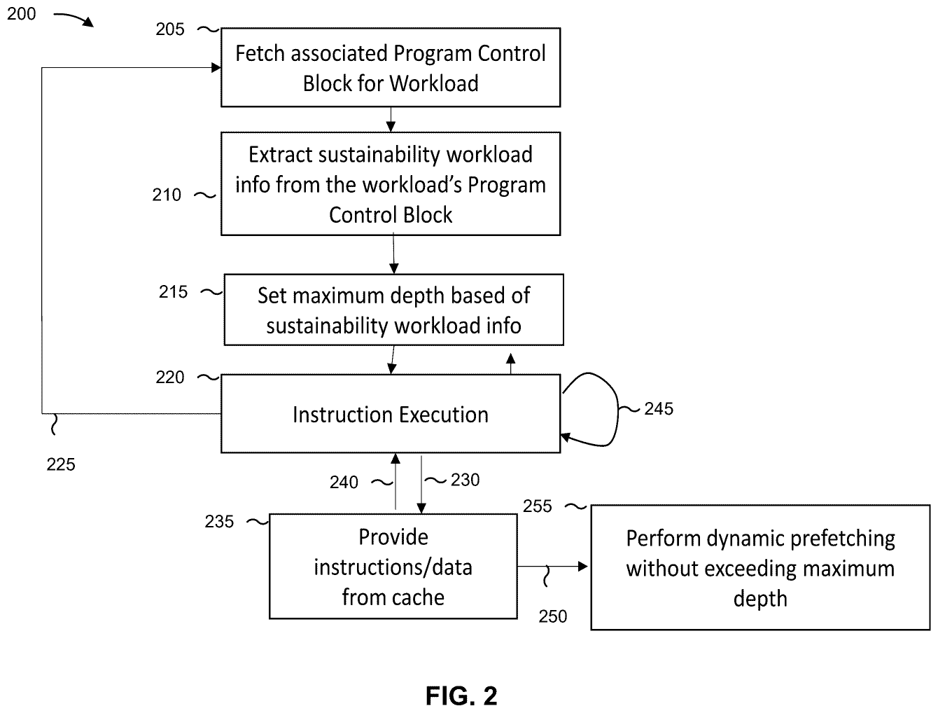

FIG. 2 is a flowchart of an example process associated with limiting cache prefetching based on sustainability information. In some implementations, one or more process blocks of FIG. 2 may be performed by a CPU (e.g., CPU 105). Additionally, or alternatively, one or more process blocks of FIG. 2 may be performed by one or more components of device 400, such as processor 420, memory 430, storage component 440, input component 450, output component 460, and/or communication component 470.

As shown in FIG. 2, process 200 may include fetching associated program context block (block 205). For example, CPU 105 may fetch a program context block of a current workload as part of switching from executing a previous workload to executing the current workload. The program context block may include sustainability information regarding the current workload (e.g., a sustainability level for a current process associated with the current workload).

As shown in FIG. 2, process 200 may include extract sustainability information from the program context block about the currently executed workload (block 210). For example, CPU 105 may determine that the requested information is not stored in the cache. In this regard, CPU 105 may determine that cache prefetching may be performed to obtain the requested information. Accordingly, CPU 105 (e.g., using sustainable prefetch algorithm 130) may determine whether a cache prefetching depth limit exists for the current workload. In order to determine whether the cache prefetching depth limit exists, CPU 105 may obtain the sustainability information for the current workload from the program context block of the current workload. In some situations, when a process executes, an operating system may load state (e.g., save registers) to CPU 105 and may conduct a context switch. The registers may be locations where the values operated on by CPU 105, actually reside. When programs switch (via changing the program context block), the registers may be saved for the exiting program, and the registers of the incoming program may be restored. A load state may typically include this restoration of registers for the program as well as any other necessary architecture dependent configurations, if any.

As shown in FIG. 2, process 200 may include setting a maximum depth based on sustainability information (block 215). For example, CPU 105 may set cache prefetching depth limit based on the sustainability information. For example, CPU 105 may determine that a cache prefetching depth limit exists for the current workload. In this regard, CPU 105 may analyze the sustainability information to determine a measure of importance of the current workload and/or determine whether the sustainability information identifies a cache prefetching depth limit. For instance, based on the sustainability information, CPU 105 may determine a measure of importance of the current workload. For instance, based on the sustainability information, CPU 105 may determine that a measure of performance to be achieved with respect to executing the current workload is a lower level of performance. Based on determining that the current workload is to be executed to achieve a lower level of performance, CPU 105 may determine that a cache prefetching depth limit is associated with executing the current workload. For example, CPU 105 may determine that, for lower level of performance, sustainability is to be prioritized over performance. Additionally, or alternatively, the sustainability information may identify a cache prefetching depth limit. Accordingly, CPU 105 may determine that a cache prefetching depth limit is associated with executing the current workload.

Based on determining that the cache prefetching depth limit is associated with executing the current workload, CPU 105 may set the cache prefetching depth limit during execution of the current workload. In some situations, based on the sustainability information, CPU 105 may determine that a measure of performance to be achieved with respect to executing the current workload is a higher level of performance. For example, CPU 105 may determine that, for higher level of performance, performance is to be prioritized over sustainability. Based on determining that the current workload is to be executed to achieve a higher level of performance, CPU 105 may determine that a cache prefetching depth limit is not associated with executing the current workload. Additionally, or alternatively, the sustainability information may not identify a cache prefetching depth limit. Accordingly, CPU 105 may determine that a cache prefetching depth limit is not associated with executing the current workload.

As shown in FIG. 2, process 200 may include performing instructions execution (block 220). For example, following the context switch, CPU 105 may execute instructions of the workload (e.g., the process). In some examples, the instruction may be part one of three types of instructions. Each instruction may trigger different flows, such as a) a context switch being initiated (at 225), (b) a memory accessing instruction being executed (at 230) triggering interactions with the cache, and (c) any other instructions. The instructions may include register based operations, such as mathematical operations amongst two registers, evaluating conditional statements, or bitwise operations.

As shown in FIG. 2, process 200 may include, following (block 220), once a current process is de-scheduled (e.g., no longer scheduled) and another process is scheduled, another PCB (or a task control block (TCB)) will be selected, and another context switching may be performed. In some embodiments, another PCB (or another TCB) may be selected once a current process is de-scheduled and another process is scheduled. In some embodiments, another PCB (or another TCB) may be selected once a current thread is de-scheduled and another thread is scheduled.

As shown in FIG. 2, process 200 may include providing instructions/data from cache (block 235). For example, the memory accessing instructions (at 230) may cause cache accesses (e.g., of a cache 115) and state changes (e.g., via load/store, instruction fetches and cache evictions). The cache 115 may provide the instructions/data (at 240). Process 200, associated with executing the instructions (at block 220), may be reiterated with a next instruction (at 245). After providing the instructions/data, the cache 115 may initiate cache prefetching (at 250). In some situations, cache prefetching may be initiated based on the memory access pattern observed from the instruction execution (at 230). For example, the memory access pattern may indicate that cache prefetching has been performed.

As shown in FIG. 2, process 200 may include performing dynamic prefetching without exceeding maximum depth (block 255). For example, sustainable prefetch algorithm 130 may use the sustainability information (from the PCB loaded at the context switch time into the hardware state for limiting cache prefetching. For instance, based on setting the cache prefetching depth limit, CPU 105 may perform cache prefetching up to a depth (or level) identified by the cache prefetching depth limit.

By performing cache prefetching up to a depth (or level) identified by the cache prefetching depth limit, a cache prefetch speculation may be limited. In some instances, the cache prefetching depth limit may preserve energy consumption. In some embodiments, the cache prefetching depth limit may limit a depth of a Markov chain. In some embodiments, the cache prefetching depth limit may limit a threshold of calculated speculation of a possible fetch.

As indicated above, FIG. 2 is provided as an example. Other examples may differ from what is described regarding FIG. 2. The number and arrangement of devices shown in FIG. 1 are provided as an example. A network, formed by the devices shown in FIG. 2 may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

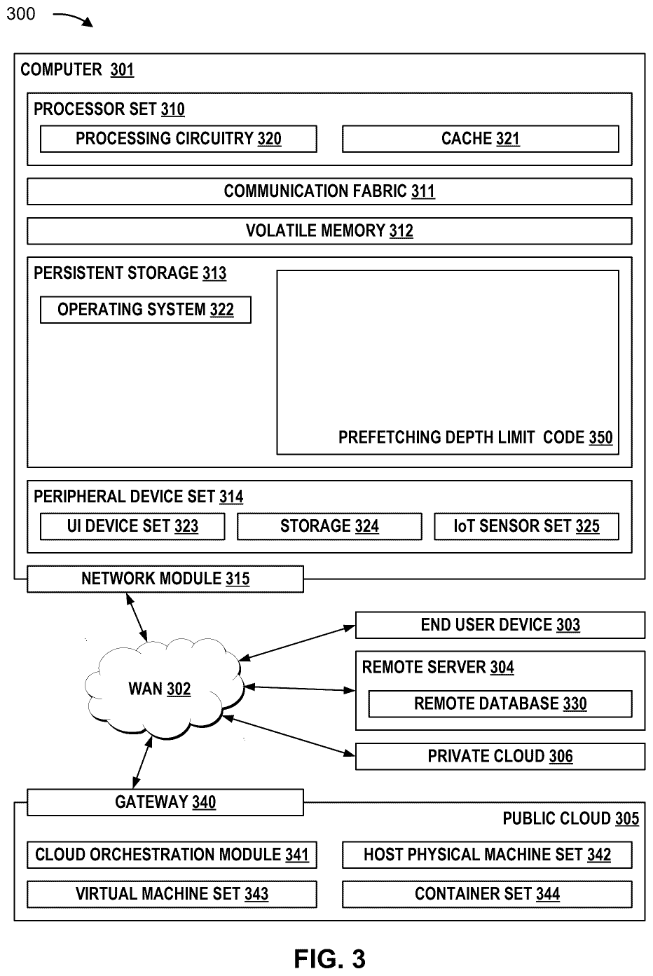

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as prefetching depth limit code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computational resources of public cloud 305 is performed by the computer hardware and/or software of cloud orchestration module 341. The computational resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computational resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

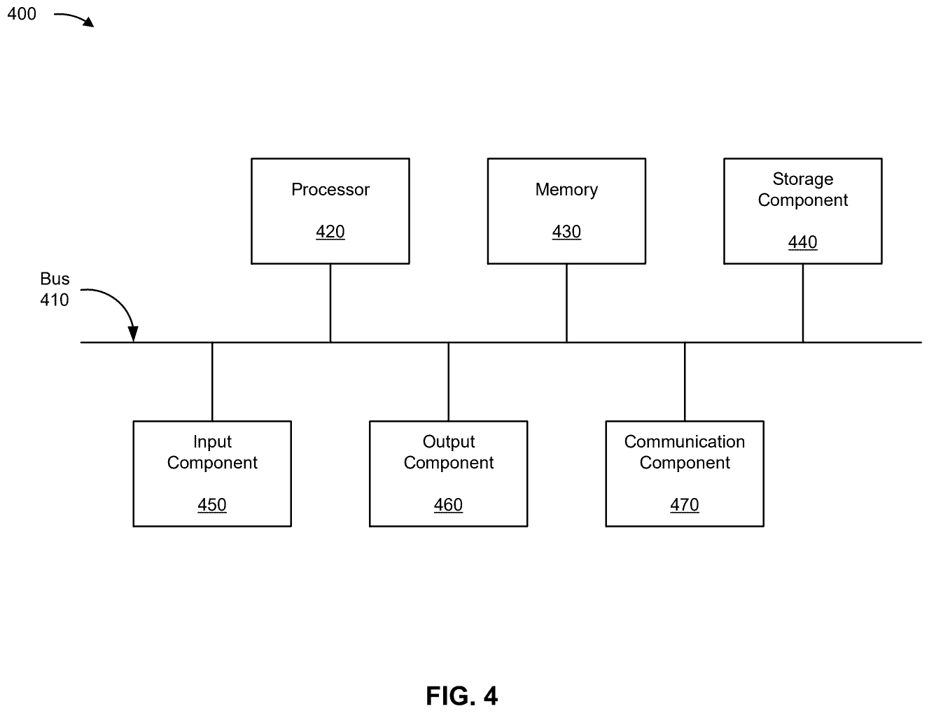

FIG. 4 is a diagram of example components of a device 400, which may correspond to CPU 105. In some implementations, CPU 105 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

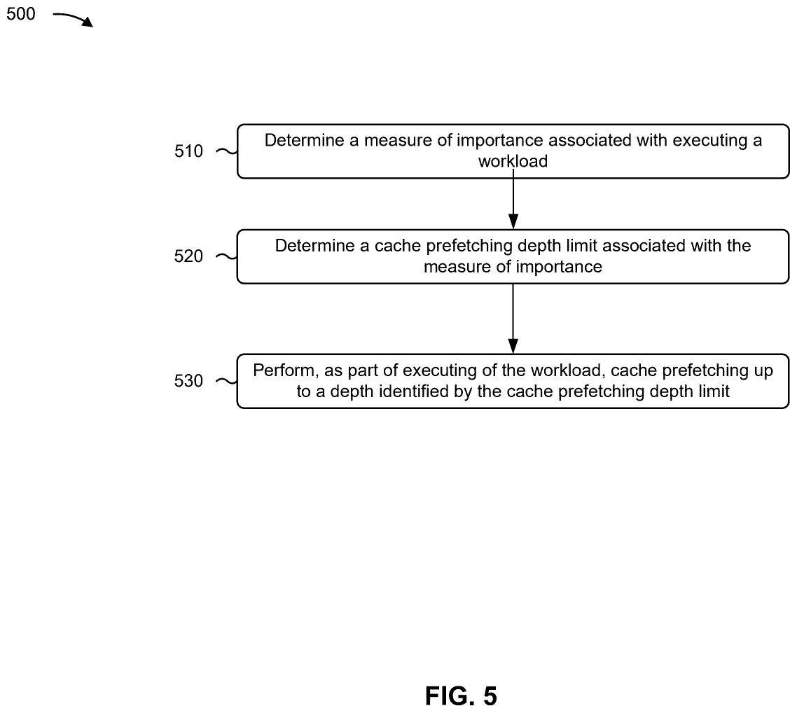

FIG. 5 is a flowchart of an example process 500 associated with configurable depth limit for cache prefetching brief description of the drawings. In some implementations, one or more process blocks of FIG. 5 may be performed by a central processing unit (e.g., central processing unit 105). In some implementations, one or more process blocks of FIG. 5 may be performed by one or more components of device 400, such as processor 420, memory 430, storage component 440, input component 450, output component 460, and/or communication interface 470.

As shown in FIG. 5, process 500 may include determining a measure of importance associated with executing a workload (block 510). For example, the central processing unit may determine a measure of importance associated with executing a workload, as described above.

As further shown in FIG. 5, process 500 may include determining a cache prefetching depth limit associated with the measure of importance (block 520). For example, the central processing unit may determine a cache prefetching depth limit associated with the measure of importance, as described above.

As further shown in FIG. 5, process 500 may include performing, as part of executing of the workload, cache prefetching up to a depth identified by the cache prefetching depth limit (block 530). For example, the central processing unit may perform, as part of executing the workload, cache prefetching up to a depth identified by the cache prefetching depth limit, as described above.

In some implementations, process 500 includes detecting a switch from a first program context block to a second program context block associated with the workload, and determining a cache prefetching depth limit based on detecting the switch from the first program context block to the second program context block.

In some implementations, process 500 includes obtaining sustainability information from the second program context block associated with the workload, and determining the cache prefetching depth limit based on the sustainability information.

In some implementations, process 500 includes obtaining sustainability information from the second program context block associated with the workload, and determining the measure of importance based on the sustainability information.

In some implementations, determining the cache prefetching depth limit comprises determining that resources and energy are to be preserved based on the sustainability information, and determining the cache prefetching depth limit based on determining that the resources and energy are to be preserved.

In some implementations, determining the measure of importance comprises determining a measure of performance to be achieved with respect to executing the workload, and wherein determining the cache prefetching depth limit comprises determining a cache prefetching depth limit associated with the measure of importance.

In some implementations, performing the cache prefetching comprises applying the cache prefetching depth limit to a Markov prefetching algorithm.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
determining a measure of importance associated with executing a workload;
determining a cache prefetching depth limit associated with the measure of importance; and
performing, as part of executing of the workload, cache prefetching up to a depth identified by the cache prefetching depth limit.

2. The computer-implemented method of claim 1, further comprising:
detecting a context switch associated with executing the workload; and
determining the cache prefetching depth limit based on detecting the context switch.

3. The computer-implemented method of claim 2, further comprising:
obtaining sustainability information from a program context block associated with the workload; and
determining the cache prefetching depth limit based on the sustainability information.

4. The computer-implemented method of claim 2, further comprising:
obtaining sustainability information from a program context block associated with the workload; and
determining the measure of importance based on the sustainability information.

5. The computer-implemented method of claim 4, wherein determining the cache prefetching depth limit comprises:
determining that resources and energy are to be preserved based on the sustainability information; and
determining the cache prefetching depth limit based on determining that the resources and energy are to be preserved.

6. The computer-implemented method of claim 1, wherein determining the measure of importance comprises:
determining a measure of performance to be achieved with respect to executing the workload; and
wherein determining the cache prefetching depth limit comprises:
determining a cache prefetching depth limit associated with the measure of importance.

7. The computer-implemented method of claim 1, wherein performing the cache prefetching comprises:
applying the cache prefetching depth limit to a Markov prefetching algorithm.

8. A system comprising:
a processing unit to:
determine that one or more instructions are to be stored in a cache for execution of a workload;
obtain sustainability information regarding cache prefetching associated with the execution of the workload;
determine, based on the sustainability information, whether the cache prefetching is to be limited to a cache prefetching depth limit;
perform the cache prefetching up to the cache prefetching depth limit when the cache prefetching is to be limited to the cache prefetching depth limit; and
perform the cache prefetching independent of the cache prefetching depth limit when the cache prefetching is not to be limited to the cache prefetching depth limit.

9. The system of claim 8, wherein, to perform the cache prefetching up to the cache prefetching depth limit, the processing unit is to:
applying the cache prefetching depth limit to a Markov prefetching algorithm.

10. The system of claim 8, wherein, to determine whether the cache prefetching is to be limited to the cache prefetching depth, the processing unit is to:
determine, based on the sustainability information, that resources and energy are to be preserved during the execution of the workload; and
determine the cache prefetching depth limit based on determining that the resources and energy are to be preserved.

11. The system of claim 8, wherein the processing unit is to:
detect a switch from a first program context block to a second program context block associated with the workload;
determine whether the cache prefetching is to be limited to the cache prefetching depth based on detecting the switch from the first program context block to the second program context block; and
obtain the sustainability information from the second program context block.

12. The system of claim 11, wherein the processing unit is to:
detect a switch from a first thread to a second thread associated with the workload; and
determine whether the cache prefetching is to be limited to the cache prefetching depth based on detecting the switch from the first thread to the second thread.

13. The system of claim 8, wherein the processing unit is to:
determine, based on the sustainability information, a measure of importance associated with executing the workload; and
determine, based on the measure of importance, whether the cache prefetching is to be limited to the cache prefetching depth limit.

14. The system of claim 8, wherein the processing unit is to:
determine, based on the sustainability information, a measure of performance to be achieved with respect to executing the workload; and
determine, based on the sustainability information, the cache prefetching depth limit associated with the measure of importance.

15. A computer program product comprising:
one or more computer readable storage media, and program instructions collectively stored on the one or more computer readable storage media, the program instructions comprising:
program instructions to determine that one or more instructions are to be stored in a cache for execution of a workload;
program instructions to obtain sustainability information regarding cache prefetching associated with the execution of the workload; and
program instructions to perform, as part of the execution of the workload, cache prefetching to a cache prefetching depth limit when the sustainability information identifies the cache prefetching depth.

16. The computer program product of claim 15, wherein the program instructions further comprise:
program instructions to perform the cache prefetching independent of the cache prefetching depth when the sustainability information does not identify the cache prefetching depth.

17. The computer program product of claim 15, wherein the program instructions further comprise:
program instructions to determine, based on the sustainability information, a measure of importance associated with executing the workload; and
program instructions to determine, based on the measure of importance, whether the cache prefetching is to be limited to the cache prefetching depth limit.

18. The computer program product of claim 15, wherein the program instructions further comprise:
program instructions to detect a switch from a first program context block to a second program context block associated with the workload; and
program instructions to determine whether the cache prefetching is to be limited to the cache prefetching depth based on detecting the switch from the first program context block to the second program context block.

19. The computer program product of claim 18, wherein the program instructions further comprise:
program instructions to obtain the sustainability information from the second program context block.

20. The computer program product of claim 18, wherein the program instructions further comprise:
program instructions to determine, based on the sustainability information, that resources and energy are to be preserved during the execution of the workload; and
program instructions to determine the cache prefetching depth limit based on determining that the resources and energy are to be preserved.
